(19) United States
(12) Patent Application Publication
(10) Pub. No.: US 2005/0123179 A1
(43) Pub. Date: Jun. 9, 2005

(54) Method and system for automatic axial rotation correction in vivo images

(75) Inventors: Shoupu Chen, Rochester, NY (US); Lawrence A. Ray, Rochester, NY (US); Nathan D. Cahill, West Henrietta, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/729,756

(22) Filed: Dec. 5, 2003

(51) Int. Cl. G06K 9/00; G06K 9/36

(52) U.S. Cl. 382/128; 382/289

(57) ABSTRACT

A digital image processing method for automatic axial rotation correction for in vivo images, comprising selecting, as a reference image, a first arbitrary in vivo image from a plurality of in vivo images, and subsequently, finding a rotation angle between a second arbitrary in vivo image selected from the plurality of in vivo images and the reference image. The method next corrects the orientation of the second arbitrary in vivo image, with respect to orientation of the reference image and corresponding to the rotation angle, before finding the rotation angle between other selected in vivo images and the reference image. Additionally, the method corrects for the other selected in vivo images that do not match the reference image's orientation and where there exists a rotation angle between the other selected in vivo images and the reference image.

### FIELD OF THE INVENTION

The present invention relates generally to an endoscopic imaging system and, in particular, to axial rotation correction of in vivo images.

### BACKGROUND OF THE INVENTION

Several in vivo measurement systems are known in the art. They include swallowed electronic capsules which collect data and which transmit the data to an external receiver system. These capsules, which are moved through the digestive system by the action of peristalsis, are used to measure pH (“Heidelberg” capsules), temperature (“CoreTemp” capsules) and pressure throughout the gastro-intestinal (GI) tract. They have also been used to measure gastric residence time, which is the time it takes for food to pass through the stomach and intestines. These capsules typically include a measuring system and a transmission system, wherein the measured data is transmitted at radio frequencies to a receiver system.

U.S. Pat. No. 5,604,531, assigned to the State of Israel, Ministry of Defense, Armament Development Authority, and incorporated herein by reference, teaches an in vivo measurement system, in particular an in vivo camera system, which is carried by a swallowed capsule. In addition to the camera system, there is an optical system for imaging an area of the GI tract onto the imager and a transmitter for transmitting the video output of the camera system. The capsule is equipped with a number of LEDs (light emitting diodes) as the lighting source for the imaging system. The overall system, including a capsule that can pass through the entire digestive tract, operates as an autonomous video endoscope. The electronic capsule images even the difficult to reach areas of the small intestine.

U.S. Pat. No. 6,632,175, assigned to Hewlett-Packard Development Company, L. P., and incorporated herein by reference, teaches a design of a swallowable data recorder medical device. The swallowable data recorder medical device includes a capsule having a sensing module for sensing a biological condition within a body. A recording module is provided including an atomic resolution storage device.

U.S. patent application No. 2003/0023150 A1, assigned to Olympus Optical Co., LTD., and incorporated herein by reference, teaches a design of a swallowed capsule-type medical device for conducting examination, therapy, or treatment, which travels through the inside of the somatic cavities and lumens of human beings or animals. Signals, including images captured by the capsule-type medical device, are transmitted to an external receiver and recorded on a recording unit. The images recorded are retrieved in a retrieving unit, displayed on the liquid crystal monitor and compared, by an endoscopic examination crew, with past endoscopic disease images that are stored in a disease imaging database.

One problem associated with the capsule imaging system is that when the capsule moves forward along the GI tract, there inevitably exists an axial rotation of the capsule around its own axis. This axial rotation causes inconsistent orientation of the captured images, which in turn causes diagnosis difficulties.

Hua Lee, et al. in their paper entitled “Image analysis, rectification and re-rendering in endoscopy surgery” (see http://www.ucop.edu/research/micro/abstracts/2k055.html), incorporated herein by reference, describes a video-endoscopy system used for assisting surgeons to perform minimal incision surgery. A scope assistant holds and positions the scope in response to the surgeon's verbal directions. The surgeon's visual feedback is provided by the scope and displayed on a monitor. The viewing configuration in endoscopy is ‘scope-centered'. A large, on-axis rotation of the video scope and the camera will change the orientation of the body anatomy. The effect of that is the surgeon easily gets disoriented after repeated rotation of the scope view.

Note, Hua et al. teaches a method for a controllable endoscopic video system (controlled by an human assistant). The axial rotation of the video camera can be predicted and corrected. Furthermore, the axial rotation can be eliminated by using a robotic control system such as ROBDOC™ (see, http://www.robodoc.com/eng/index.html).

Other endoscopic video systems are uncontrollable systems. The camera is carried by a peristalsis propelled capsule. The axial rotation of the capsule is random, therefore, unpredictable.

There is a need therefore for an improved endoscopic imaging system that overcomes the problems set forth above.

These and other aspects, objects, features and advantages of the present invention will be more clearly understood and appreciated from a review of the following detailed description of the preferred embodiments and appended claims, and by reference to the accompanying drawings.

### SUMMARY OF THE INVENTION

The need is met according to the present invention by providing a digital image processing method for automatic axial rotation correction for in vivo images that includes selecting, as a reference image, a first arbitrary in vivo image from a plurality of in vivo images, and subsequently, finding a rotation angle between a second arbitrary in vivo image selected from the plurality of in vivo images and the reference image. The method next corrects the orientation of the second arbitrary in vivo image, with respect to orientation of the reference image and corresponding to the rotation angle, before finding the rotation angle between other selected in vivo images and the reference image. Additionally, the method corrects for the other selected in vivo images that do not match the reference image's orientation and where there exists a rotation angle between the other selected in vivo images and the reference image.

### BRIEF DESCRIPTION OF THE DRAWINGS

FIG. 1 is a prior art block diagram illustration of an in vivo camera system;

FIG. 2 is an exemplary illustration of the concept of an examination bundle according to the present invention;

FIG. 2A is an exemplary illustration of the concept of an examination bundlette according to the present invention;

FIG. 3A is a flowchart illustrating information flow for a real-time abnormality detection method;

FIG. 3B is a flowchart illustrating information flow of the in vivo image with axial rotation correction of the present invention;

FIG. 4 is a schematic diagram of an exemplary examination bundlette processing hardware system useful in practicing the present invention;

FIG. 5 is a flowchart illustrating the in vivo image axial rotation correction method according to the present invention;

FIG. 6A is a graph showing an in vivo imaging system capsule in a GI tract;

FIG. 6B is a graph illustrating three-dimensional coordinate systems of the in vivo imaging system at three locations in a GI tract;

FIG. 6C is a graph illustrating an in vivo image plane and its two-dimensional coordinate system;

FIG. 6D illustrates an in vivo image with an object and another in vivo image with an rotated object;

FIG. 7 is a graph illustrating an optic flow image;

FIG. 8A illustrates an optic flow image simulating a camera moving forward along its optical axis while rotating around its optical axis;

FIG. 8B illustrates an optic flow image simulating a camera moving rotating around its optical axis, and

FIG. 8C illustrates an optic flow image simulating a camera rotating around its optical axis.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

During a typical examination of a body lumen, the in vivo camera system captures a large number of images. The images can be analyzed individually, or sequentially, as frames of a video sequence. An individual image or frame without context has limited value. Some contextual information is frequently available prior to or during the image collection process; other contextual information can be gathered or generated as the images are processed after data collection. Any contextual information will be referred to as metadata.

Metadata is analogous to the image header data that accompanies many digital image files.

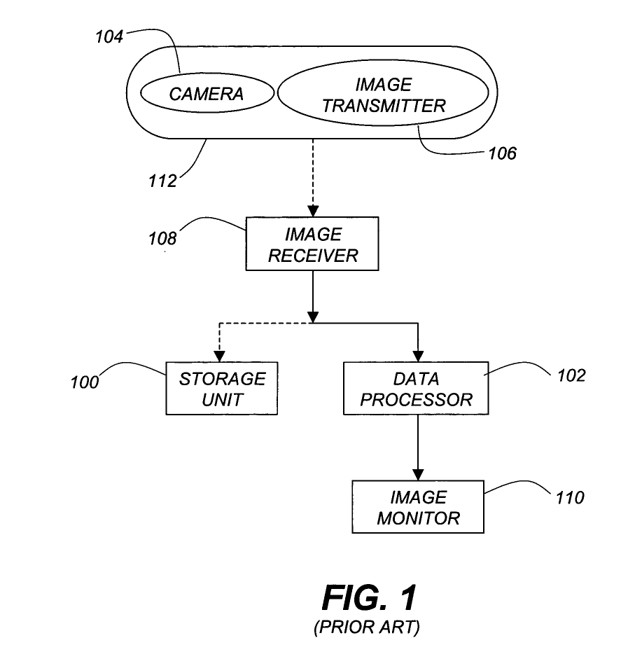

FIG. 1 shows a block diagram of the in vivo video camera system described in U.S. Pat. No. 5,604,531. The system captures and transmits images of the gastro-intestinal (GI) tract while passing through the gastro-intestinal lumen. The system contains a storage unit 100, a data processor 102, a camera 104, an image transmitter 106, an image receiver 108, which usually includes an antenna array (not shown herein), and an image monitor 110. Storage unit 100, data processor 102, image monitor 110, and image receiver 108 are located outside the patient's body. Camera 104, as it transits the GI tract, is in communication with image transmitter 106 located in capsule 112 and image receiver 108 located outside the body. Data processor 102 transfers frame data to and from storage unit 100 while the former analyzes the data. Data processor 102 also transmits the analyzed data to image monitor 110 where a physician views it. The data can be viewed in real time or at some later date.

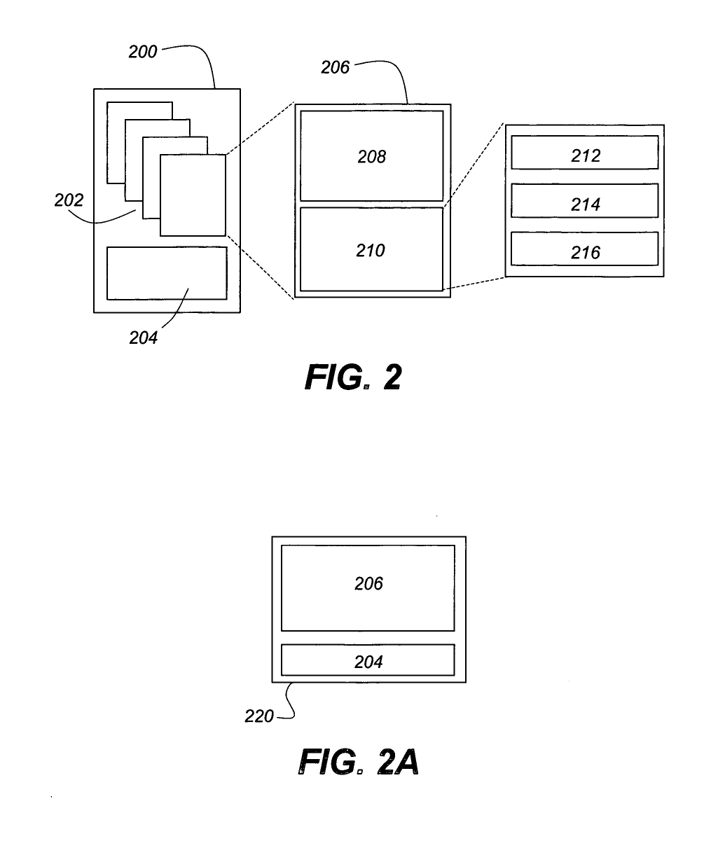

Referring to FIG. 2, the complete set of all images captured during the examination, along with any corresponding metadata, will be referred to as an examination bundle 200. The examination bundle 200 consists of a collection of image packets 202 and a section containing general metadata 204.

An image packet 206 comprises two sections: the pixel data 208 of an image that has been captured by the in vivo camera system, and image specific metadata 210. The image specific metadata 210 can be further refined into image specific collection data 212, image specific physical data 214 and inferred image specific data 216. Image specific collection data 212 contains information such as the frame index number, frame capture rate, frame capture time, and frame exposure level. Image specific physical data 214 contains information such as the relative position of the capsule when the image was captured, the distance traveled from the position of initial image capture, the instantaneous velocity of the capsule, capsule orientation, and non-image sensed characteristics such as pH, pressure, temperature, and impedance. Inferred image specific data 216 includes location and description of detected abnormalities within the image, and any pathologies that have been identified. This data can be obtained either from a physician or by automated methods.

The general metadata 204 contains such information as the date of the examination, the patient identification, the name or identification of the referring physician, the purpose of the examination, suspected abnormalities and/or detection, and any information pertinent to the examination bundle 200. It can also include general image information such as image storage format (e.g., GIF, TIFF or JPEG-based), number of lines, and number of pixels per line.

Referring to FIG. 2A, the image packet 206 and the general metadata 204 are combined to form an examination bundlette 220 suitable for real-time abnormality detection.

It will be understood and appreciated that the order and specific contents of the general metadata or image specific metadata may vary without changing the functionality of the examination bundle.

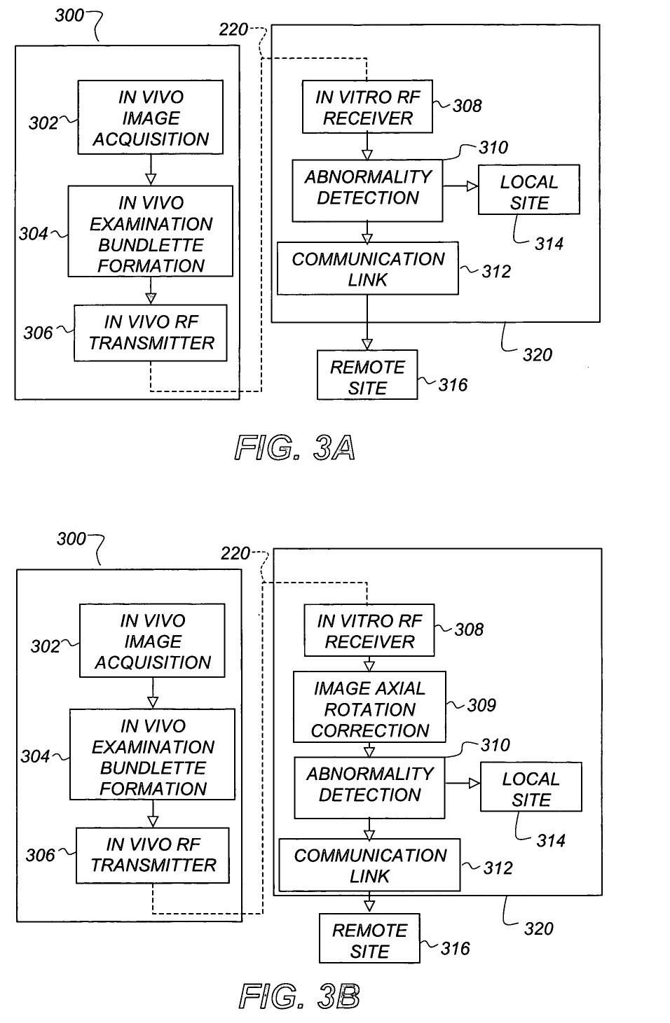

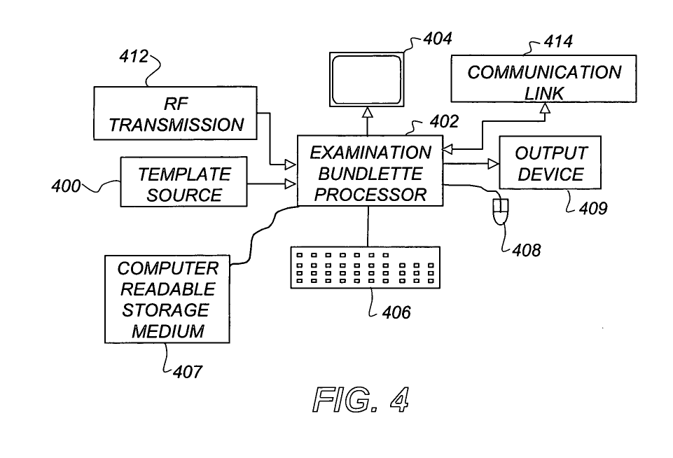

Referring now to FIG. 3A and specific components shown in FIG. 2, an exemplary application of the capsule in vivo imaging system is described. FIG. 3A is a flowchart illustrating a real-time automatic abnormality detection method. In FIG. 3A, an in vivo imaging system 300 can be realized by using systems such as the swallowed capsule described in U.S. Pat. No. 5,604,531. An in vivo image 208 (as shown in FIG. 2) is captured in an in vivo image acquisition step 302. In a step of In Vivo Examination Bundlette Formation 304, the image 208 is combined with image specific data 210 to form an image packet 206. The image packet 206 is further combined with general metadata 204 and compressed to become an examination bundlette 220. The examination bundlette 220 is transmitted to a proximal in vitro computing device through radio frequency in a step of RF transmission 306. An in vitro computing device 320 is either a portable computer system attached to a belt worn by the patient or in near proximity. Alternatively, it is a system such as shown in FIG. 4 and will be described in detail later. The transmitted examination bundlette 220 is received in the proximal in vitro computing device 320 by an In Vivo RF Receiver 308.

Data received in the in vitro computing device 320 is examined for any sign of disease in Abnormality detection operation 310. Details of the step of abnormality detection can be found in commonly assigned, co-pending U.S. patent application Ser. No. (our docket 86558), entitled “METHOD AND SYSTEM FOR REAL-TIME AUTOMATIC ABNORMALITY DETECTION OF IN VIVO IMAGES”, and which is incorporated herein by reference.

FIG. 3B shows a diagram of information flow of the present invention. To ensure effective detection and diagnosis of an abnormality, images from RF Receiver 308 are adjusted in a step of Image axial rotation correction 309 before the abnormality detection operation 310 takes place (see FIG. 3B).

The step of Image axial rotation correction 309 is specifically detailed in FIG. 5. Any alarm signals from step 310 will be sent to a local site 314 and to a remote health care site 316 through communication connection 312. An exemplary communication connection 312 could be a broadband network connected to the in vitro computing system 320. The connection from the broadband network to the in vitro computing system 320 could be either a wired connection or a wireless connection. Again, the in vitro computing device 320 could be a portable computer system attached to a belt worn by the patient.

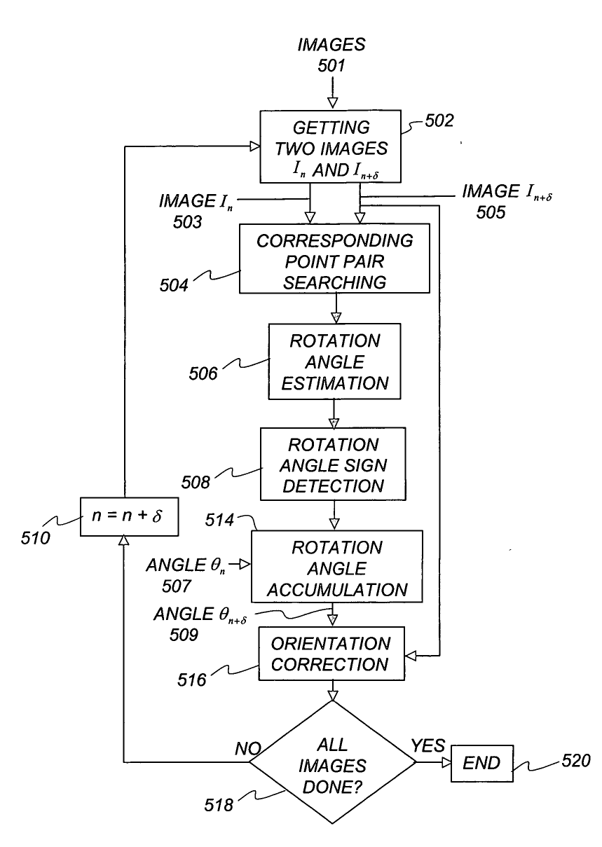

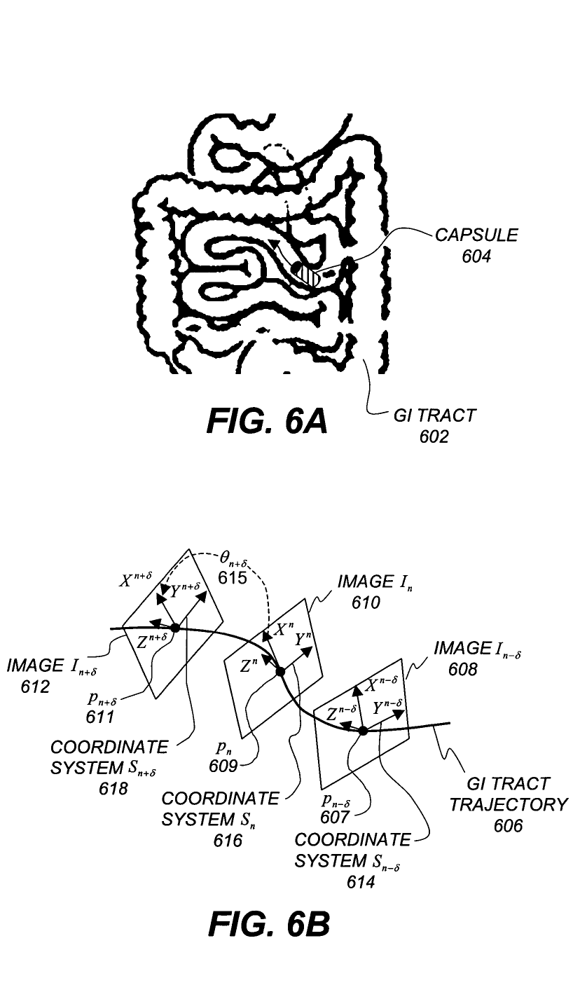

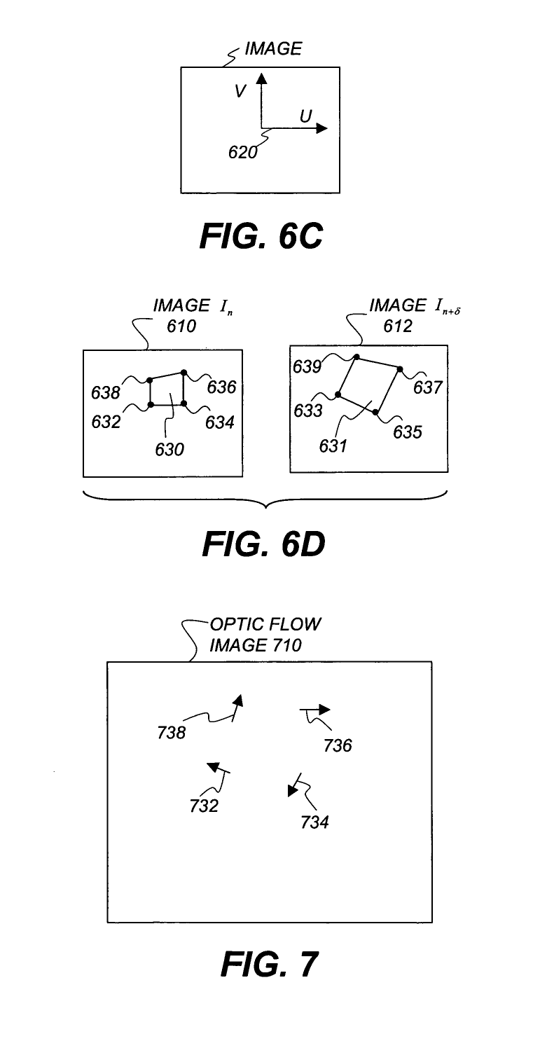

A plurality of images 501 received from RF receiver 308 are input to operation 502 of “Getting two images” (a first arbitrary image and a second arbitrary image) Iₙ and I_{n+δ}, where n is an index of an image sequence, δ is an index offset. An exemplary value for δ is 1. The in vivo camera is carried by a peristalsis propelled capsule. Axial rotation of the capsule causes the image plane to rotate about its optical axis. Exemplary images in step 502 are shown in FIG. 6B. For clarity, detailed description of the remaining operational steps (503, 504, 505, 506, 507, 508, 509, 510, 514, 516, 518, and 520) of FIG. 5 are discussed in a later section, once the angular relationship between successive image planes is explained.

Along a GI tract 606, there are images (planes) I_{n-δ} (608), in (610) and I_{n+δ} (612) at GI positions p_{n-δ} (607), pₙ (609) and p_{n+δ} (611) respectively. There are three-dimensional coordinate systems, S_{n-δ} (614), Sₙ (616) and S_{n+δ} (618) attached to images I_{n-δ}, Iₙ and I_{n+δ} accordingly.

The X and Y axes of the three-dimensional systems S_{n-δ} (614), Sₙ (616) and S_{n+δ} (618) are aligned with the V and U axes of a two-dimensional coordinate system of the corresponding images (planes) I_{n-δ} (608), Iₙ (610) and I_{+δ} (612). An exemplary two-dimensional coordinate system (620) of an image with the U and V axes is shown in FIG. 6C. Note that the origin of the two-dimensional coordinate system is at the center of the image plane. The Z axes of the three-dimensional systems S_{n-δ} (614), Sₙ (616) and S_{n+δ} (618) are perpendicular to their corresponding image planes I_{n-δ} (608), Iₙ (610) and I_{n+δ} (612). The Z axes of the three-dimensional systems S_{n-δ} (614), Sₙ (616) and S_{n+δ} (618) are aligned with optical axes of the in vivo camera at the corresponding positions where images I_{n-δ} (608), Iₙ (610) and I_{n+δ} (612) are captured. When the camera rotates around its optical axis, the three-dimensional system attached to the camera image plane also rotates around its Z axis. The rotation angle is defined respective to a right-hand system or a left-hand system as is known to ordinary people skilled in the art. This rotation makes fixed objects (the inner walls of the GI tract) in the three-dimensional space rotate in an opposite direction in the rotated three-dimensional coordinate system. This phenomenon is illustrated in FIG. 6D. An object 630 is projected onto image plane Iₙ (610) at position pₙ (609). Object 630 has four corner points 632, 634, 636 and 638. When the in vivo camera advances to position p_{n+δ} (611) there is a counterclockwise rotation θ_{n+δ} (615) around the Z axis associated with the camera forward motion. The object in image I_{n+δ} (612) captured at position p_{n+δ} (611) appears to rotate clockwise with −θ_{n+δ} degrees in addition to a magnification effect due to the camera forward motion. Object 631 has four corner points 633, 635, 637 and 639. If image plane Iₙ (610) is taken as a reference plane, the four points (633, 635, 637 and 639) in image plane I_{n+δ} (612) appear to move away from their original positions (points 632, 634, 636 and 638) in the reference image plane. This motion of points in the image plane can be described using a common terminology, ‘optic flow’ which is widely adopted in the computer vision community.

FIG. 7 illustrate the optic flow image 710 of object 630 in image 610 (shown in FIG. 6D). Arrows 732, 734, 736 and 738 indicate the motion direction of points 632, 634, 636 and 638 to points 633, 635, 637 and 639 of object 631 in a reference plane.

The method of the present invention is to determine the rotation angle θ, in general, between consecutive image coordinate systems (angle between the V axes or between U axes of two images) in order to perform rotation correction. This task is accomplished first by finding corresponding point pairs in consecutive images in a step of Corresponding point pair searching 504. Exemplary corresponding point pairs are 632-633, 634-635, 636-637, and 638-639 (as shown in FIG. 6D). There are abundantly well known algorithms to fulfill this corresponding point pair searching task. For example, a phased-based image motion estimation method that is not sensitive to low-pass variations in image intensity where shadows and illumination vary (see “Phase-based Image Motion Estimation and Registration,” by Magnus Hemmendorff, Mats T. Andersson, and Hans Knutsson,

http://www.telecom.tuc.gr/paperdb/icassp99/PDF/AUTHOR/IC991287.PDF).

The estimation of angle between two consecutive images is performed in step 506 (shown in FIG. 5) of Rotation angle estimation. In general, this estimation can be realized by using algorithms such as 2D-2D absolute orientation detection (see “Computer and Robot Vision,” by Robert M. Haralick and Linda G. Shapiro) as an exemplary scheme.

Once again, referring to FIG. 6D, Using image planes Iₙ (610) and I_{n+δ} (612) as exemplary images, denote T 2D coordinate points from Iₙ (610) by I₁ⁿ, . . . , p_{T}ⁿ (for example, points 632, 634, 636 and 638, and here T=4). These could correspond to the points in I_{+δ} (612) denoted by p₁^{n+δ}, . . . , p_{T}^{n+δ} (for example, points 633, 635, 637 and 639). Note, this correspondence has been accomplished in step 504 (shown in FIG. 5) of Corresponding point pair searching. This 2D orientation detection attempts to determine from the corresponding point pairs (for example, pairs 632-633, 634-635, 636-637, and 638-639) a more precise estimate of a rotation matrix R and a translation d such that pₜ^{n+δ}=Rpₜⁿ+d,t=1, . . . , T. Since errors are likely embedded in step of Corresponding point pair searching 504, the real problem becomes a minimization problem. Determine R and d such that the weighted sum of the residual errors ε² is minimized:

$${ɛ}^{2} = {\sum }_{t = 1}^{T} {w}_{t} {‖ {p}_{t}^{n + δ} - ( {Rp}_{t}^{n} + d ) ‖}^{2} \qquad ( 1 )$$

The weights wₜ≧0 and Σₜ₌₁^{T}wₜ=1. Exemplary value of the weights could be wₜ=1/T.

First, taking the partial derivative of Equation (1) with respective to the translation d and setting the partial derivative to 0 yields
d=\overline{p}^{n+δ}−R\overline{p}ⁿ (2)
where \overline{p}^{n+δ}=Σₜ₌₁^{T}wₜpₜ^{n+δ} and \overline{p}ⁿ=Σₜ₌₁^{T}wₜpₜⁿ. Applying Equation (2) in Equation (1) results in

$${ɛ}^{2} = {\sum }_{t = 1}^{T} {w}_{t} [ {( {p}_{t}^{n + δ} - {\overline{p}}^{n + δ} )}^{′} ( {p}_{t}^{n + δ} - {\overline{p}}^{n + δ} ) - 2 ( {p}_{t}^{n + δ} - {\overline{p}}^{n + δ} ) R ( {p}_{t}^{n} - {\overline{p}}^{n} ) + {( {p}_{t}^{n} - {\overline{p}}^{n} )}^{′} ( {p}_{t}^{n} - {\overline{p}}^{n} ) ] \qquad ( 3 )$$

Notice the fact that

$$R = [ \begin{matrix}cos ( {θ}_{n + δ} ) & - sin ( {θ}_{n + δ} ) \\ sin ( {θ}_{n + δ} ) & cos ( {θ}_{n + δ} ) \end{matrix} ] \qquad ( 4 )$$

Notice also that every point such as 632, 634, 636, 638, 633, 635, 637 or 639 in the image plane is represented by a two-dimensional vector in the U-V coordinate system as shown in FIG. 6C. Therefore, pₜⁿ and pₜ^{n+δ} can be expressed as

$$\begin{matrix}{p}_{t}^{n} = ( \begin{matrix}{p}_{u , t}^{n} \\ {p}_{v , t}^{n}\end{matrix} ) and {p}_{t}^{n + δ} = ( \begin{matrix}{p}_{u , t}^{n + δ} \\ {p}_{v , t}^{n + δ}\end{matrix} ) \\ and & ( 5 ) \\ {\overline{p}}^{n} = ( \begin{matrix}{\overline{p}}_{u}^{n} \\ {\overline{p}}_{v}^{n}\end{matrix} ) and {\overline{p}}^{n + δ} = ( \begin{matrix}{\overline{p}}_{u}^{n + δ} \\ {\overline{p}}_{v}^{n + δ}\end{matrix} ) & ( 6 )\end{matrix}$$

Applying Equations (4), (5) and (6) to Equation (3) and setting to zero the partial derivative of ε² with respect to θ_{n+δ} results in 0=A sin(θ_{n+δ})+B cos(θ_{n+δ})

$$where$$

$$A = {\sum }_{t = 1}^{T} {w}_{t} [ ( {p}_{u , t}^{n + δ} - {\overline{p}}_{u}^{n + δ} ) ( {p}_{u , t}^{n} - {\overline{p}}_{u}^{n} ) + ( {p}_{v , t}^{n + δ} - {\overline{p}}_{v}^{n + δ} ) ( {p}_{v , t}^{n} - {\overline{p}}_{v}^{n} ) ]$$

$$and$$

$$B = {\sum }_{t = 1}^{T} {w}_{t} [ ( {p}_{u , t}^{n + δ} - {\overline{p}}_{u}^{n + δ} ) ( {p}_{u , t}^{n} - {\overline{p}}_{u}^{n} ) + ( {p}_{v , t}^{n + δ} - {\overline{p}}_{v}^{n + δ} ) ( {p}_{v , t}^{n} - {\overline{p}}_{v}^{n} ) ] .$$

The absolute value of the rotation angle θ_{n+δ} can be computed as
|θ_{n+δ}|=cos⁻¹(A/\sqrt{A²+B²}) (7)
After finding the absolute value of the rotation angle (for example, θ_{n+δ}) between two consecutive image planes (for example, planes Iₙ (610) and I_{n+δ} (612)), the next step is to find the rotation direction, or the sign of the rotation angle in a step of Rotation angle sign detection 508. The operation of rotation angle sign detection 508 is explained by using a computer-driven simulated case.

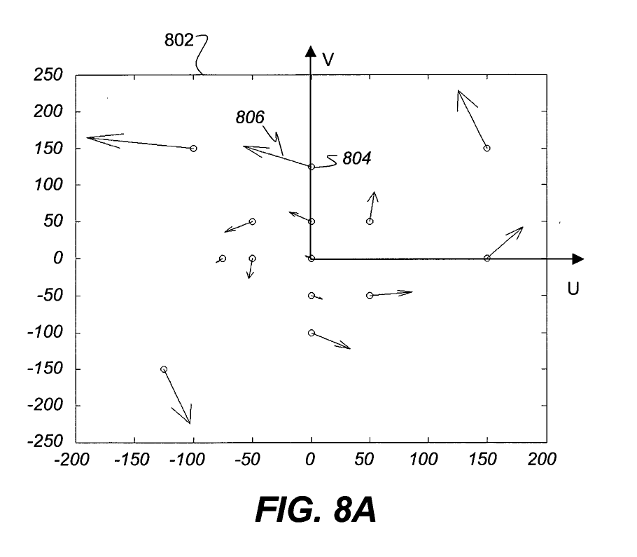

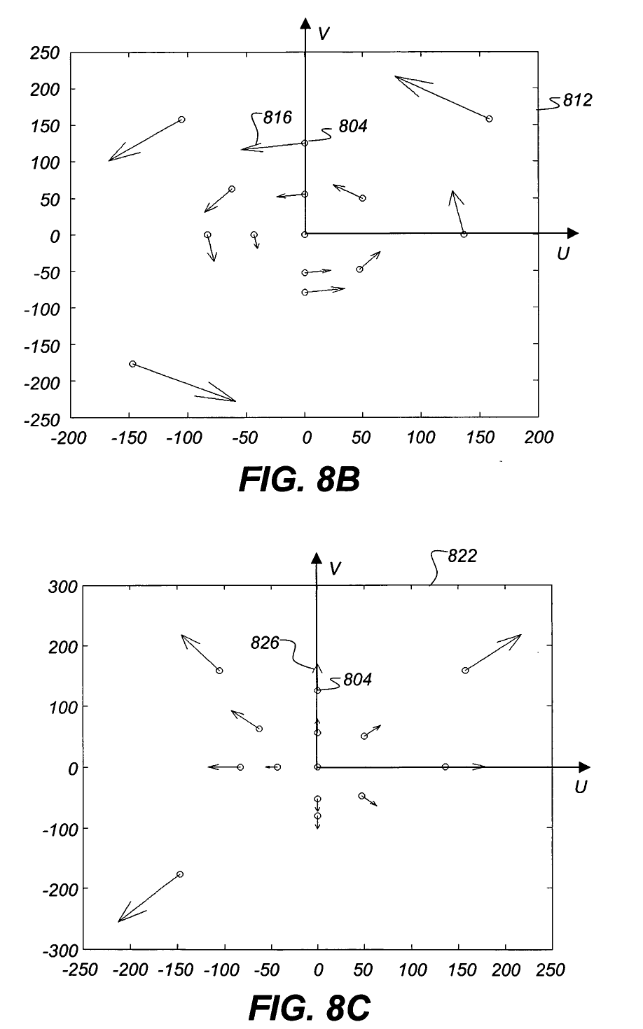

FIG. 8 displays the computer simulated optic flow of a set of 2D points (fourteen points) in two consecutive image planes, for example, planes Iₙ (610) and I_{n+δ} (612) (shown in FIG. 6B). These fourteen points are the perspective projections of fourteen non-coplanar points in the three-dimensional space. The focal length of the simulated camera is one unit (exemplary unit is inch). Image plane Iₙ (610) is used as a reference plane. With respect to image plane Iₙ (610), image plane I_{n+δ} (612) (in fact, the camera) rotates an exemplary 18 degrees clockwise around its optical axis that is aligned with the Z-axis of the three-dimensional coordinate system. Image plane I_{n+δ} (612) (in fact, the camera) also moves forward along its optical axis, or the Z-axis of the three-dimensional coordinate system, by an exemplary distance of 0.5 units (exemplary unit is inch) toward the cloud of fourteen non-coplanar points in the three-dimensional space. Arrows such as 806 in graph 802 of FIG. 8A illustrate the optic flow of imaged points such as 804 moving from their positions in image plane Iₙ (610) to their positions in image plane I_{n+δ} (612).

Recall that the simulated motion includes translation along the Z-axis (moving forward) and rotation around the Z-axis. Hence, arrows such as 806 can be decomposed into two components: a translational component and a rotational component. Graph 812 in FIG. 8B illustrates the rotational component of optic flow in FIG. 8A. Arrow 816 is the rotational component of arrow 806 for point 804 (shown in FIG. 8A) due to the rotation of the camera. Graph 822 in FIG. 8C illustrates the translational component of optic flow in FIG. 8A. Arrow 826 is the translational component of arrow 806 for point 804 (shown in FIG. 8A) due to the forward motion of the camera. Notice that image point 804 is a projection of a three-dimensional point on the X axis in the three-dimensional space. If the camera has only translation motion along its optical axis or the Z-axis of the three-dimensional coordinate system, the new position of point 804 resides on the V axis of the image plane (see exemplary arrow 826 in graph 822). This rule applies to other points on the V axis. Likewise, if the camera has only translation motion along its optical axis or the Z-axis of the three-dimensional coordinate system, the new position of a point on U axis resides on the U axis of the new image plane. In general, if the camera has only translation motion along its optical axis or the Z-axis of the three-dimensional coordinate system, the new position of a point anywhere in the image plane is on a line passing through the point and the origin. Now returning back to FIG. 8A, optic flow arrow 806 for point 804 pointing to negative U direction reveals that there exists a rotational component of the optic flow pointing to the negative U direction as well, just as arrow 816 shown in FIG. 8B. A rotational component of the optic flow pointing to the negative U direction indicates that the camera rotates clockwise. On the other hand, a rotational component of the optic flow pointing to the positive U direction indicates that the camera rotates counterclockwise. Therefore, by evaluating the optic flow of points on the V axis, the direction (of the sign) of the rotation angle of the camera can be determined. People skilled in the art can easily extend this analysis to points that are not on the V axis. As for the simulated case, using Equations (1) through (7) and the sign detection method stated above, the rotation angle is computed as 17.9 degrees clockwise from the coordinate system of image plane Iₙ (610) to the coordinate system of image plane I_{n+δ} (612) (both are shown in FIG. 6D).

Referring again to FIG. 5, there is a step of Rotation angle accumulation 514. For a sequence of in vivo images, the user could select any one image among the available images as the reference image and apply axial rotation correction to all the other images. The corrected images are not necessarily consecutive images of the reference image. For example, if image I_{-δ} is selected as the reference image, then image I_{n+δ} has to be rotated by an angle θ_{n+δ} so that image I_{n+δ} will have the same orientation as image I_{n-δ}. Image points matching algorithms such as optic flow computation performs best when they are applied to two images with extensive overlaps (regions having the same objects). Obviously, image I_{n+δ} has more overlaps with image Iₙ than with image I_{n-δ}. So the real rotation angle θ_{n+δ} for orientation correction, if I_{n-δ} is selected as the reference image, is the accumulated rotation angle from I_{n-δ} to I_{n+δ} computed using Equations (1) through (7) and the sign detection method stated above. In step 516 of Orientation correction, compute

$${\hat{I}}_{n + δ} = \hat{R} {I}_{n + δ} , where \hat{R} = [ \begin{matrix}cos ( - {θ}_{n + δ} ) & - sin ( - {θ}_{n + δ} ) \\ sin ( - {θ}_{n + δ} ) & cos ( - {θ}_{n + δ} ) \end{matrix} ] .$$

orientation as I_{-δ}, if I_{-δ} is selected as the reference image.

The flow chart in FIG. 5 is an example embodiment of the present invention, where the axial rotation correction starts from I₀. That is, n is initialized as zero. Set δ to one. Use I₀ as the reference image, find the rotation angle and the direction of the angle for I₁ using operations 504, 506, 508 and 514. After I₁ is axial rotation corrected, an operation query 518 is performed to see if all images are processed. If so, the algorithm goes to ending operation 520, otherwise, the algorithm increases n by δ, then gets I₂. Use the original I₁ (before axial rotation correction) to find the angle between I₁ and I₂. The process continues until all the images are corrected.

The axial rotation correction has been formulated in terms of optic flow technology. People skilled in the art should be able to formulate the problem using other technologies such as motion analysis, image correspondence analysis and so on. The axial rotation correction can be realized in real-time or offline.

FIG. 4 shows an exemplary of an examination bundlette processing, including the axial rotation correction hardware system useful in practicing the present invention that includes a template source 400 and an RF receiver 412. The template from the template source 400 is provided to an examination bundlette processor 402, such as a personal computer, or a work station such as a Sun Sparc™ workstation. The RF receiver 412 passes the examination bundlette to the examination bundlette processor 402. The examination bundlette processor 402 preferably is connected to a CRT display 404, an operator interface, such as a keyboard 406 and/or a mouse 408. Examination bundlette processor 402 is also connected to computer readable storage medium 407. The examination bundlette processor 402 transmits processed and adjusted digital images including axial rotation correction and metadata to an output device 409. Output device 409 can comprise a hard copy printer, a long-term image storage device, or another processor networked together. The examination bundlette processor 402 is also linked to a communication link 414 or a telecommunication device connected, for example, to a broadband network.

The invention has been described in detail with particular reference to certain preferred embodiments thereof, but it will be understood that variations and modifications can be effected within the spirit and scope of the invention.

### Parts List

100 Storage Unit
102 Data Processor
104 Camera
106 Image Transmitter
108 Image Receiver
110 Image Monitor
112 Capsule
200 Examination Bundle
202 Image Packets
204 General Metadata
206 Image Packet
208 Pixel Data
210 Image Specific Metadata
212 Image Specific Collection Data
214 Image Specific Physical Data
216 Inferred Image Specific Data
220 Examination Bundlette
300 In Vivo Imaging system
302 In Vivo Image Acquisition
304 Forming Examination Bundlette
306 RF Transmission
306 Examination Bundlette Storing
308 RF Receiver
309 Image axial rotation correction
310 Abnormality Detection
312 Communication Connection
314Local Site
316 Remote Site
320 In Vitro Computing Device
400 Template source
402 Examination Bundlette processor
404 Image display
406 Data and command entry device
407 Computer readable storage medium
408 Data and command control device
409 Output device
412 RF transmission
414 Communication link
501 images
502 Getting two images
503 image
504 Corresponding point pair searching
505 image
506 Rotation angle estimation
507 angle
510 Rotation angle sign detection
514 angle
510 a step
508 Rotation angle accumulation
510 Orientation correction
518 All images done?
520 end
602 GI tract
604 capsule
606 GI tract Trajectory
607 position point
608 image plane
609 position point
610 image plane
611 position point
612 image plane
614 coordinate system
615 an angle
616 coordinate system
618 coordinate system
620 two-dimensional coordinate system
630 an image object
631 an image object
632 an image point
633 an image point
634 an image point
635 an image point
636 an image point
637 an image point
638 an image point
639 an image point
710 an optic flow image
732 an arrow
734 an arrow
736 an arrow
738 an arrow
802 a simulated camera motion optic flow image
804 an image point
806 an arrow
812 a simulated camera motion optic flow image
816 an arrow
822 a simulated camera motion optic flow image
626 an arrow

1. A digital image processing method for automatic axial rotation correction of in vivo images, comprising the steps of:
a) selecting, as a reference image, a first arbitrary in vivo image from a plurality of in vivo images;
b) finding a rotation angle between a second arbitrary in vivo image selected from the plurality of in vivo images and the reference image;
c) correcting the orientation of the second arbitrary in vivo image, with respect to orientation of the reference image and corresponding to the rotation angle;
d) finding the rotation angle between other selected in vivo images and the reference image; and
e) correcting for the other selected in vivo images that do not match the reference image's orientation and where there exists a rotation angle between the other selected in vivo images and the reference image.

2. The digital image processing method for automatic axial rotation correction of in vivo images claimed in claim 1, wherein the rotation angle is an accumulated rotation angle from a plurality of rotated in vivo images.

3. The digital image processing method for automatic axial rotation correction of in vivo images claimed in claim 2, wherein the step of correcting the orientation of any arbitrary in vivo image, with respect to orientation of the reference image and corresponding to the rotation angle uses an accumulated correction angle derived from the accumulated rotation angle.

4. The digital image processing method for automatic axial rotation correction of in vivo images claimed in claim 1, wherein the rotation angle is measured with respect to an optical axis of an in vivo camera used to capture the plurality of in vivo images, and wherein the optical axis is perpendicular to an image plane and is parallel to the in vivo camera's travel trajectory derivative.

5. The digital image processing method for automatic axial rotation correction of in vivo images claimed in claim 1, wherein the rotation angle is defined in a right-hand system or a left-hand system.

6. The digital image processing method for automatic axial rotation correction of in vivo images claimed in claim 5, wherein the rotation angle is rotated counter-clock wise or clockwise relative to the reference image's orientation, such that the rotation angle is a signed value.

7. The digital image processing method for automatic axial rotation correction of in vivo images claimed in claim 1, wherein the plurality of in vivo images have a plurality of feature points, and wherein the plurality of feature points are used for finding an orientation difference between two in vivo images.

8. The digital image processing method for automatic axial rotation correction of in vivo images claimed in claim 7, wherein an origin of a two-dimensional coordinate system of the in vivo images, thus defining an image plane, is at an image's center, and further comprising the steps of:
a) collecting the plurality of feature points that reside on an axis of a first image plane;
b) finding a corresponding plurality of feature points in a second image plane;
c) determining whether a feature point that resides on the axis of the first image plane moves off the axis in the second image plane; and
d) measuring the feature point's movement off the axis in the second image plane to determine the rotation angle and its direction.

9. A computer storage medium having instructions stored therein for causing a computer to perform the method of claim 1.

10. A computer storage medium having instructions stored therein for causing a computer to perform the method of claim 2.

11. A computer storage medium having instructions stored therein for causing a computer to perform the method of claim 3.

12. A computer storage medium having instructions stored therein for causing a computer to perform the method of claim 4.

13. A computer storage medium having instructions stored therein for causing a computer to perform the method of claim 5.

14. A computer storage medium having instructions stored therein for causing a computer to perform the method of claim 6.

15. A computer storage medium having instructions stored therein for causing a computer to perform the method of claim 7.

16. A computer storage medium having instructions stored therein for causing a computer to perform the method of claim 8.
